(19) United States
(12) Patent Application Publication
(10) Pub. No.: US 2008/0155352 A1
(43) Pub. Date: Jun. 26, 2008

(54) METHOD AND SYSTEM FOR CARRYING OUT AN OPERATION BASED ON A LOG RECORD OF A COMPUTER PROGRAM

(76) Inventors: Senthil Bakthavachalam, Croton-on-Hudson, NY (US); Hariharan Balakrishnan, Croton-on-Hudson, NY (US); Ramendra Kumar Sahoo, Mohegan Lake, NY (US)

Correspondence Address: HOFFMAN, WARNICK & D'ALESSANDRO LLC, 75 State Street, 14th Floor, ALBANY, NY, 12207, US

(21) Appl. No.: 11/555,402

(22) Filed: Nov. 1, 2006

(51) Int. Cl. G06F 11/00

(52) U.S. Cl. 714/45

(57) ABSTRACT

The invention provides a method and system for carrying out an operation based on a log record of a computer program.

### BACKGROUND OF THE INVENTION

1. Technical Field

The invention relates generally to information processing, and more particularly, to a method and system for carrying out an operation based on a log record of a computer program.

2. Background Art

Logging infrastructure in enterprise system software is vital to the smooth running of a data center. Every application, including system software, maintains and generates log records during the course of their runtime. To use and maintain these, a “logger” accepts a log record, and any associated trace messages, and logs it. The logger then passes the log record to a “handler,” which is ultimately tasked with storing the log record (e.g., to a file in a file system, to a network address, to a table in a relational database, etc.). A handler may, therefore, be operable to carry out any number of operations on the log record (e.g., encrypting, compressing, transforming to another program language, etc.). A handler may also be operable to carry out operations external to the log record (e.g., resetting a system clock, increasing a cache size, backing up a database, etc.). The types of operations a handler may carry out are virtually unlimited.

Due to the large number of operations that may need to be carried out based on the contents of a log record, a large number of handlers are typically employed in a “handler chain,” each handler being operable to carry out only one or a few operations. Thus, a log record may be passed to a great many handlers, the operations of which, in any given case, are inapplicable. This is both inefficient and computationally expensive.

To this extent, a need exists for overcoming the deficiencies known in the art.

### SUMMARY OF THE INVENTION

The invention provides a method and system for carrying out an operation based on a log record of a computer program.

A first aspect of the invention provides a computer-implemented method for carrying out an operation based on a log message of a computer program, the method comprising: generating a log message from a computer program; appending to the log message at least one remedy token identifying an operation to be carried out; assembling a remedy handler chain comprising at least one remedy handler operable to carry out the operation; dispatching the log message through the remedy handler chain; and carrying out the operation using the at least one remedy handler.

A second aspect of the invention provides a system for carrying out an operation based on a log record of a computer program, the system comprising: a system for appending to a log message generated from a computer program at least one remedy token identifying an operation to be carried out; a system for assembling a remedy handler chain comprising at least one remedy handler operable to carry out the operation; a system for dispatching the log message through the remedy handler chain; and a system for carrying out the operation using the at least one remedy handler.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawing that depicts various embodiments of the invention, in which:

FIG. 1 shows a diagram of an illustrative method and system according to the invention.

It is noted that the drawings of the invention are not to scale. The drawings are intended to depict only typical aspects of the invention, and therefore should not be considered as limiting the scope of the invention.

### DETAILED DESCRIPTION

As indicated above, the invention provides a method and system for carrying out an operation based on a log record of a computer program.

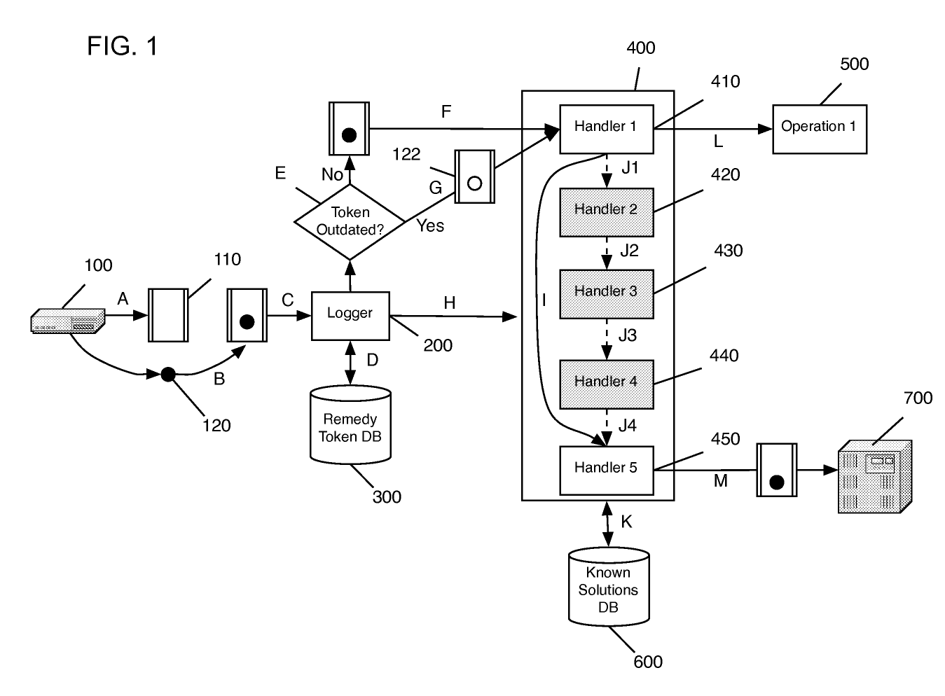

Referring now to FIG. 1, an illustrative method and system according to the invention are shown. A computer program operating on a computer 100 generates A a log record 110. To log record 110 is appended B a remedy token 120 identifying an operation to be carried out. Remedy token 120 may be appended by the computer program generating log record 110 or by another computer program.

The operation identified by remedy token 120 may include virtually any operation capable of being carried out by a computer system. Such an operation may be external to the log record (e.g., accessing an external database, moving/transferring/downloading a file, correcting an error in the operation of the computer program, etc.) or internal to the log record (e.g., reformatting the log record, copying the log record to a system directory, transferring the log record to a storage device, etc.).

In any case, log record 110, with remedy token 120 appended, is then passed C to a logger 200. Logger 200 may, optionally, query D a remedy token database 300 to determine E whether remedy token 120 has been updated. If so (i.e., “Yes” at step E), logger 200 may append an updated remedy token 122 to log record 110. A remedy token 120 may be updated, for example, if the preferred operation to be carried out has changed. If remedy token 120 has not been updated (i.e., “No” at step E), remedy token 120 will remain unchanged, as appended to log record 110. In either case, log record 110 (with either remedy token 120 or updated remedy token 122 appended) is then passed F or G, respectively, to a handler chain 400 comprising one or more handlers 410-450 operable to carry out one or more operation.

In order to avoid the noted deficiency in the art of having to pass a log record through a handler chain containing a number of handlers, the operations of which are inapplicable to a particular log record, logger 200 according to the present invention assembles H a handler chain 400 based on remedy token 120 (or updated remedy token 122). Thus, only handlers applicable to carrying out the operation identified by remedy token 120 (or updated remedy token 122) are included in handler chain 400. For example, as shown in FIG. 1, handler chain 400 includes five handlers 410-450. However, based on remedy token 120 (or updated remedy token 122), only Handler 1 410 and Handler 5 450 are applicable to log record 110. Thus, as assembled H by logger 200, handler chain 400 includes only Handler 1 410 and Handler 5 450 (Handlers 2-4 420-440 being shown shaded in grey), with log record 110 being passed I directly from Handler 1 410 to Handler 5 450. That is, assembling H a handler chain 400 according to the invention may include removing from an existing handler chain 400 one or more handlers 420-440. In the case that all five handlers 410-450 were applicable, log record 110 may be passed J1 from Handler 1 410 to Handler 2 420, then passed J2 to Handler 3 430, then passed J3 to Handler 4, and finally passed J4 to Handler 5.

Each handler included in handler chain 400 (e.g., 410, 450) may be operable to carry out one or more operations applicable to log record 110. For example, Handler 1 410 is operable to carry out L Operation 1 500. In doing so, Handler 1 410 may query a database of known solutions 600 for carrying out Operation 1. For example, if Operation 1 500 includes reformatting log record 110, the database of known solutions 600 may include details regarding such formatting. Thus, one need only update the database of known solutions 600 in order to affect a change in how Handler 1 410 carries out Operation 1 500 with respect to all log records.

As shown in FIG. 1, Handler 5 450 is operable to store M log record 110 in an external storage device 700. Log record 110 may be stored with remedy token 120 (or updated remedy token 122) appended, as shown. Alternatively, log record 110 may be stored without a remedy token 120,122 appended or may be stored by each handler in handler chain 400, with each stored log record including an indication of the operation performed by the handler. An advantage of the latter is that the operations carried out based on remedy token 120 (or updated remedy token 122) may be reconstructed using the stored log records.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A computer-implemented method for carrying out an operation based on a log message of a computer program, the method comprising:
generating a log message from a computer program;
appending to the log message at least one remedy token identifying an operation to be carried out;
assembling a remedy handler chain comprising at least one remedy handler operable to carry out the operation;
dispatching the log message through the remedy handler chain; and
carrying out the operation using the at least one remedy handler.

2. The method of claim 1, further comprising:
storing the log message.

3. The method of claim 1, further comprising:
accessing a database of remedy tokens;
determining whether the appended remedy token is outdated; and
in the case that the appended remedy token is outdated, replacing the appended remedy token with an updated remedy token.

4. The method of claim 1, wherein assembling includes removing at least one remedy handler from an existing remedy handler chain.

5. The method of claim 1, wherein carrying out the operation includes accessing a database of known solutions for carrying out the operation.

6. The method of claim 1, wherein the operation includes correcting an error in the operation of the computer program.

7. A system for carrying out an operation based on a log record of a computer program, the system comprising:
a system for appending to a log message generated from a computer program at least one remedy token identifying an operation to be carried out;
a system for assembling a remedy handler chain comprising at least one remedy handler operable to carry out the operation;
a system for dispatching the log message through the remedy handler chain; and
a system for carrying out the operation using the at least one remedy handler.
